(19) United States
(12) Patent Application Publication
(10) Pub. No.: US 2013/0105744 A1
(43) Pub. Date: May 2, 2013

(54) ULTRAVIOLET TRANSMITTING NEAR INFRARED CUT FILTER GLASS

(71) Applicant: ASAHI GLASS COMPANY, LIMITED, Chiyoda-ku (JP)

(72) Inventors: Tomonori OGAWA, Chiyoda-ku (JP); Akio Koike, Chiyoda-ku (JP); Yuki Kondo, Chiyoda-ku (JP); Hiroyuki Ohkawa, Chiyoda-ku (JP)

(73) Assignee: ASAHI GLASS COMPANY, LIMITED, Chiyoda-ku (JP)

(21) Appl. No.: 13/658,375

(22) Filed: Oct. 23, 2012

Related U.S. Application Data
(63) Continuation of application No. PCT/JP2011/059984, filed on Apr. 22, 2011.

(30) Foreign Application Priority Data
Apr. 23, 2010 (JP) 2010-100056
Jul. 13, 2010 (JP) 2010-158708

(51) Int. Cl. G02B 5/22

(52) U.S. Cl. CPC G02B 5/226
USPC 252/587; 65/32.5

(57) ABSTRACT

To provide a near infrared cut filter glass which can suppress the near infrared transmittance to be low while maintaining a high ultraviolet transmittance, at a low cost.

Ultraviolet transmitting near infrared cut filter glass comprising, as represented by mass %, from 50 to 85% of P₂O₅, from 1 to 20% of Al₂O₃, from 1 to 5% of B₂O₃, from 0 to 2% of Li₂O, from 0 to 15% of Na₂O, from 0 to 20% of K₂O, from 7 to 20% of Li₂O+Na₂O+K₂O, from 0 to 2% of MgO, from 0 to 1% of CaO, from 0 to 4% of SrO, from 1 to 22% of BaO, from 1 to 22% of MgO+CaO+SrO+BaO, from 0.1 to 2% of CuO, from 0 to 1% of Co₃O₄ and from 0 to 5% of Sb₂O₃.

### TECHNICAL FIELD

The present invention relates to ultraviolet transmitting near infrared cut filter glass to be used for high power laser optics.

### BACKGROUND ART

In recent years, techniques employing a high power laser have attracted attention in various fields such as lithography for production of semiconductors, laser processing, laser fusion, medical technology and verification of pure science.

Further, miniaturization of lithography and miniaturization of laser processing are in progress by employing a shorter laser wavelength and employing light in the ultraviolet region. By use of ultraviolet light, processing with suppressed influence by heat is possible, by which metals and glass and in addition, plastics and the like can also be processed. As such a high power ultraviolet laser, an excimer laser as a gas laser such as ArF (wavelength: 193 nm) or KrF (wavelength: 248 nm) may be mentioned. Further, YAG laser and YLF laser as a solid-state laser may also be mentioned, and the third harmonic (in the vicinity of 350 nm) and the fourth harmonic (in the vicinity of 265 nm) thereof may be mentioned.

The fundamental oscillation wavelength of such a solid-state laser is a near infrared ray in the vicinity of 1,050 nm, which is converted to a high order harmonic ultraviolet laser by using a wavelength conversion element (crystals). However, in the case of wavelength conversion by using such a wavelength conversion element, not 100% of the incident fundamental wave (near infrared light) is converted and a part thereof is transmitted without being converted. In such a case, an unintended near infrared light is applied to an object, and such may cause heat deformation or temperature change.

Accordingly, use of a near infrared cut filter glass having a specific substance which absorbs near infrared light added thereto, for a high power laser, has been studied. As a near infrared cut filter, a relative spectral responsibity correction filter for a solid-state imaging element such as a CCD or a CMOS which is an image sensor for a digital camera, video camera or the like, although not for a high power laser, may be mentioned (Patent Documents 1 and 2). As such near infrared cut filter glass, optical glass comprising aluminophosphate glass or fluorophosphates glass and having CuO added thereto, so as to selectively absorb light in the near infrared region and to have a high weather resistance, has been proposed (Patent Documents 3, 4 and 5).

### PRIOR ART DOCUMENTS

### Patent Documents

Patent Document 1: JP-A-1-242439
Patent Document 2: JP-A-55-80737
Patent Document 3: JP-A-6-234546
Patent Document 4: JP-A-6-16451
Patent Document 5: JP-A-3-137037

### DISCLOSURE OF INVENTION

### Technical Problem

However, the present inventors have examined the spectral characteristics of conventional near infrared cut filter glass for a solid-state imaging element and found that its transmittance in the ultraviolet region particularly in the vicinity of 350 nm is not necessarily high, and the cut filter glass cannot be applicable to a high power laser as it is. Further, heretofore, there has been no specific proposal with respect to glass having a high transmittance in the ultraviolet region particularly in the vicinity of 350 nm and having excellent near infrared cutting performance.

The present invention has been made under these circumstances, and its object is to provide near infrared cult filter glass having a high ultraviolet transmittance and a low near infrared transmittance and its production method.

### Solution to Problem

The present inventors have conducted extensive studies to achieve the above object and as a result, found that near infrared cut filter glass having a lower near infrared transmittance while maintaining a high ultraviolet transmittance can be obtained by a phosphate glass composition within a specific range, as compared with conventional near infrared cut filter glass comprising phosphate glass or fluorophosphates glass.

That is, they have focused attention on that the absorptivity of light in the near infrared region by Cu²+ is increased when the strain of the structure of Cu²+ in the glass is small, and they have considered that the non-bridging oxygen is likely to be coordinated, and the strain around Cu²+ is smaller when the field strength of the modifier oxide in the glass is weaker. This is because when the strain around Cu²+ is smaller, the energy difference between bands of ²E_{g}→²T_{2g} is smaller, and the absorption peak of Cu²+ shifts to the long wavelength side. Thus, they have found a phosphate glass composition suitable as near infrared cut filter glass which has a higher absorptivity of light in the near infrared region by Cu²+ in the glass. Further, the present inventors have conducted extensive studies on the glass melting conditions and as a result, they have found a correlation between the Pt ion amount in the glass and the absorption in the vicinity of 350 nm, and achieved glass having a higher ultraviolet transmittance by suppressing melting of Pt ions into the glass at the time of melting.

It is further preferred to reduce the moisture content called β-OH in glass and to dope glass with hydrogen molecules, in order to suppress a decrease in the transmittance in the ultraviolet region at the time of irradiation with a high power laser.

The ultraviolet transmitting near infrared cut filter glass of the present invention comprises, as represented by mass %:

P₂O₅: 50 to 85%,

Al₂O₃: 1 to 20%,

B₂O₃: 1 to 5%,

Li₂O: 0 to 2%,

Na₂O: 0 to 15%,

K₂O: 0 to 20%,

Li₂O+Na₂O+K₂O: 7 to 20%,

MgO: 0 to 2%,

CaO: 0 to 1%,

SrO: 0to 4%,

BaO: 1 to 22%,

MgO+CaO+SrO+BaO: 0.5 to 22%,

CuO: 0.1 to 2%,

Co₃O₄: 0 to 1% and

Sb₂O₃ 0 to 5%.

The ultraviolet transmitting near infrared cut filter glass of the present invention is characterized in that P₂O₅/(Al₂O₃+B₂O₃)=3 to 15 and (Na₂O+K₂O)/(Li₂O+MgO+CaO+SrO+BaO)=0.1 to 15.

Further, the ultraviolet transmitting near infrared cut filter glass of the present invention is characterized by having an internal transmittance at a wavelength of 351 nm of at least 75% with a thickness of 5 mm, and having an internal transmittance at a wavelength of 1,053 nm of at most 20%.

Further, the ultraviolet transmitting near infrared cut filter glass of the present invention is characterized by containing substantially no F, PbO, As₂O₃, CeO₂, V₂O₅, SiO₂, ZnO nor rare earth element.

The present invention is characterized in that the maximum temperature at the time of melting is at most 1,200° C.

Further, it is characterized in that the β-OH concentration in the glass is at most 2.5.

Further, it is characterized in that the hydrogen molecule amount in the glass doped with hydrogen molecules is at least 1×10¹⁵ molecules/cm³ and at most 1×10¹⁸ molecules/cm³.

### Advantageous Effects of Invention

According to the present invention, ultraviolet transmitting near infrared cut filter glass having a high ultraviolet transmittance, having a low transmittance of light in the near infrared region and having a high durability against irradiation with a high power laser, can be provided at a low cost, by adjusting the phosphate glass composition to be within a specific range and by adjusting the atmosphere and the temperature at the time of melting.

### BRIEF DESCRIPTION OF DRAWINGS

FIG. 1 is a drawing illustrating the spectral transmittances of the ultraviolet transmitting near infrared cut filter glasses in Examples 1 to 4.

FIG. 2 is a drawing illustrating the spectral transmittances of the ultraviolet transmitting near infrared cut filter glasses in Examples 5 to 9.

FIG. 3 is a drawing illustrating the spectral transmittances of the ultraviolet transmitting near infrared cut filter glasses in Examples 10 to 12.

FIG. 4 is a drawing illustrating the spectral transmittances of the ultraviolet transmitting near infrared cut filter glasses in Examples 13 to 15.

FIG. 5 is a drawing illustrating the spectral transmittances of the ultraviolet transmitting near infrared cut filter glasses in Examples 16 and 17.

FIG. 6 is a drawing illustrating the relation between the wave number of the absorption peak of Cu²+ and the field strength of each element.

FIG. 7 is a drawing illustrating spectral transmittances before and after the ultraviolet transmitting near infrared cut filter glass in Example 10 is irradiated with a laser having a wavelength of 351 nm.

FIG. 8 is a drawing illustrating the spectral transmittances with a thickness such that the internal transmittance at a wavelength of 1,053 nm of each of the ultraviolet transmitting near infrared cut filter glasses in Examples 8 to 12, 18 and 19 becomes 5%.

FIG. 9 is a drawing illustrating the relation between the melting temperature of the ultraviolet transmitting near infrared cut filter glass and the internal transmittance at a wavelength of 351 nm, in Examples 8 to 12, 18 and 19.

FIG. 10 is a drawing illustrating a TDS analysis spectrum of the ultraviolet transmitting near infrared cut filter glass in Example 10 not doped with hydrogen.

FIG. 11 is a drawing illustrating the TDS analysis spectrum of the ultraviolet transmitting near infrared cut filter glass in Example 25 doped with hydrogen.

### DESCRIPTION OF EMBODIMENTS

The present invention achieved the object by the above constitution, and the reason why the contents (as represented by mass %) of the respective components constituting the near infrared cut filter glass of the present invention are limited as above, will be describe below.

P₂O₅ is a main component forming glass (glass-forming oxide) and is a component essential to increase the near infrared shielding property, however, if its content is less than 50%, no sufficient effects will be obtained, and if it exceeds 85%, the weather resistance tends to be low. The P₂O₅ content is preferably at least 53%, more preferably at least 60%. Further, the P₂O₅ content is preferably at most 80%, more preferably at most 75%. The P₂O₅ content is particularly preferably at most 72%.

Al₂O₃ is a component essential to increase the weather resistance, however, if its content is less than 1%, no sufficient effect will be obtained, and if it exceeds 20%, glass tends to be unstable, and the near infrared shielding property tends to be low.

The Al₂O₃ content is preferably from 4 to 17%, more preferably from 7 to 11%. B₂O₃ is a component essential to lower the glass liquid phase temperature. The B₂O₃ content is at least 1%. The B₂O₃ content is preferably at least 1.5%. On the other hand, if the B₂O₃ content exceeds 5%, the near infrared shielding property tends to be low. The B₂O₃ content is preferably at most 4%, more preferably at most 3.5%.

Li₂O is not an essential component but has an effect to increase the near infrared shielding property and to soften glass, however, if the Li₂O content exceeds 2%, the glass tends to be unstable. The Li₂O content is preferably at most 1.5%, more preferably at most 1%.

Na₂O is a component to increase the near infrared shielding property and to soften glass, but is not an essential component in the present invention. If the Na₂O content exceeds 15%, glass tends to be unstable. The Na₂O content is more preferably at most 14%, particularly preferably at most 12%.

K₂O has an effect to increase the near infrared shielding property and to soften glass, but is not an essential component in the present invention. If the K₂O content exceeds 20%, the glass tends to be unstable. The K₂O content is preferably at most 17%, particularly preferably at most 15%.

If the total content of Li₂O+Na₂O+K₂O (hereinafter sometimes referred to as L+N+K) is less than 7%, the effect to increase both the near infrared shielding property and the melting property is not sufficient, and if the total content exceeds 20%, the glass tends to be unstable, and accordingly it is from 7 to 20% in the present invention. It is preferably from 7 to 18%, more preferably from 9 to 16%, particularly preferably from 10 to 15%.

MgO is not an essential component but has an effect to increase the fracture toughness of glass. However, if the MgO content exceeds 2%, the near infrared shielding property tends to be low. It is preferred that the MgO content is at most 1%, and it is more preferred that no MgO is contained.

CaO is not an essential component but has an effect to increase the fracture toughness of glass. However, if its content exceeds 1%, the near infrared shielding property tends to be low. It is preferred that the CaO content is at most 0.5%, and it is more preferred that no CaO is contained.

SrO is not an essential component but has an effect to lower the glass liquid phase temperature. However, if its content exceeds 4%, the near infrared shielding property tends to be low. It is preferably from 1 to 3%, more preferably from 2 to 3%.

BaO is a component essential to lower the glass liquid phase temperature, but if its content exceeds 22%, the near infrared shielding property tends to be low. It is preferably from 1 to 15%, more preferably from 2 to 13%.

The total content of MgO+CaO+SrO+BaO (hereinafter sometimes referred to as M+C+S+B) is from 0.5 to 22% in the present invention to increase the fracture toughness of glass and to lower the glass liquid phase temperature. If the total content is less than 0.5%, no sufficient effect will be obtained, and if it exceeds 22%, glass tends to be unstable. The total content is preferably at most 19%, more preferably at most 18.5%. Further, the total content is preferably at least 0.7%, more preferably at least 0.9%.

CuO is a component essential to increase the near infrared shielding property, but if the CuO content is less than 0.1%, no sufficient effect will be obtained, and if it exceeds 2%, the transmittance in the ultraviolet region tends to be low. The CuO content is preferably at least 0.2%, more preferably at least 0.3%. The CuO content is particularly preferably at least 0.4%. Further, the CuO content is preferably at most 1.5%, more preferably at most 1.0%. The CuO content is particularly preferably at most 0.9%.

Co₃O₄ is not an essential component but may be contained in a case where light in the vicinity of 532 nm which is the second harmonic of the solid-state laser is to be cut off. If the Co₃O₄ content is less than 0.1%, no sufficient effect will be obtained, and if the Co₃O₄ content exceeds 1%, the transmittance in the ultraviolet region will be low. If Co₃O₄ is contained, its content is preferably from 0.2% to 1%.

Sb₂O₃ is not an essential component but may be contained as a fining agent or as an oxidizing agent. If the Sb₂O₃ content is less than 0.1%, no sufficient effect will be obtained, and if the Sb₂O₃ content exceeds 5%, glass tends to be unstable. If it is contained, its content is preferably from 0.2 to 1%.

In order to obtain spectral characteristic of the near infrared cut filter glass of the present invention such that the ultraviolet transmittance is high and the transmittance of light in the near infrared region is low, specifically, the internal transmittance at 1,053 nm is suppressed while a high transmittance at 351 nm is maintained, it is important to reduce the strain of the 6 coordination structure of Cu²+ in glass and to shift the absorption peak of Cu²+ to the long wavelength side, i.e. to further increase the absorptivity of light in the near infrared region by Cu²+ in glass.

Therefore, the present inventors have considered that in order to reduce the strain of the 6 coordination structure of Cu²+ in glass, it is necessary that the number of non-bridging oxygen in glass is large and that the field strength (the field strength is a value obtained by dividing the valency Z by the square of the ion radius: Z/r², and represents the degree of the strength how a cation attracts oxygen) of the modifier oxide is small.

In order to increase the number of non-bridging oxygen in glass, it is necessary that the amount of P₂O₅ in a network oxide forming the glass network is large as compared with other network oxides. P₂O₅ contains a large amount of oxygen in its molecule as compared with Al₂O₃ or B₂O₃, and accordingly Cu²+ is likely to have non-bridging oxygen to be coordinated, and the strain around Cu²+ tends to be small.

Accordingly, as the balance of network oxides contained in glass, the P₂O₅/(Al₂O₃+B₂O₃) (hereinafter sometimes referred to as P/(A+B)) should be high, but if the ratio is too high, such may lead to a decrease in the weather resistance. Accordingly, the ratio is preferably within a range of from 3 to 15. The ratio is more preferably at least 3.5, particularly preferably at least 3.7. Further, the ratio is preferably at most 10, particularly preferably at most 7.

With respect to the field strength of the modifier oxide in glass, the relation between the wave number of the absorption peak of Cu²+ when the type of XO, is changed, which is the modifier oxide in phosphate glass comprising 70% of P₂O₅, 10% of Al₂O₃, 4% of CuO and 20% of XO_{y} (all represented by mol %), and the field strength of each element, is shown in FIG. 6. It is found that the smaller the field strength of the modifier oxide, the smaller the wave number of the absorption peak, and the more the absorptivity of light in the near infrared region by Cu²+ increases.

Accordingly, it is found to be effective to incorporate Na₂O and K₂O with a relatively small field strength in a large amount as compared with other modifier oxides, in order to make the average value of the field strength of the modifier oxides in glass to be small.

Accordingly, with respect to the balance of the modifier oxides contained in glass, the ratio (Na₂O+K₂O)/(Li₂O+MgO+CaO+SrO+BaO) should be high, however if it is too high, such may lead to a decrease in the weather resistance. Accordingly, the ratio is preferably within a range of from 0.1 to 15. Further, the ratio is more preferably at least 0.5, particularly preferably at least 0.7. On the other hand, the above ratio is preferably at most 14.9, particularly preferably at most 14.7.

The glass of the present invention preferably contains substantially no F, PbO, As₂O₃, CeO₂, V₂O₅, SiO₂, ZnO nor rare earth element. F, As₂O₃ and CeO₂ are used for conventional glass as an excellent fining agent which can form a fining gas in a wide temperature range. Further, PbO is used as a component to lower the viscosity of glass and to improve the production workability. However, as F, PbO and As₂O₃ are environmental load substances, they are preferably not contained as far as possible.

Further, if CeO₂ or V₂O₅ is contained in glass, the transmittance of the glass in the visible region tends to be low, and accordingly they are preferably not contained as far as possible in the near infrared cut filter glass of the present invention which is required to have a high transmittance in the visible region. Further, SiO₂, ZnO and a rare earth element are preferably not contained in the near infrared cut filter glass of the present invention, since if they are contained in glass, the near infrared shielding property of the glass tends to be low.

Here, “containing substantially no” means that such components are not intentionally used as materials, and inevitable impurities included from the material components or in the production step are considered to be substantially not contained. Further, considering the inevitable impurities, “containing substantially no” means a content of at most 0.05%.

The glass of the present invention preferably has a Pt content of at most 15 μg/g. Pt dissolution is mainly due to melting from a Pt crucible used. In the glass of the present invention, dissolved Pt into the glass shows absorption at from 350 to 400 nm, and accordingly the transmittance in the ultraviolet region tends to be low if the amount of Pt dissolution is large. Accordingly, in the ultraviolet transmitting near infrared cut filter glass of the present invention which is required to have a high transmittance in the ultraviolet region, the Pt content is at most 15 μg/g, more preferably at most 10 μg/g, further preferably at most 7 μg/g. The Pt content can be detected by an ICP-MS method.

The temperature when the glass of the present invention is melted is preferably at most 1,200° C. If the melting temperature exceeds 1,200° C., the amount of Pt dissolution from the Pt crucible used to the glass tends to be large, whereby absorption in the ultraviolet region will occur. Accordingly, of the ultraviolet transmitting near infrared cut filter glass of the present invention which is required to have a high transmittance in the ultraviolet region, the melting temperature is preferably at most 1,200° C., more preferably at most 1,150° C.

In order to avoid the problem of dissolving of Pt into the glass at the time of melting, use of a quartz crucible may be considered instead of the Pt crucible. When a quartz crucible is used, it is preferred to use it in an initial melting step to melt the materials until uniform glass at a certain extent is obtained, called rough melting, with a view to reducing the amount of Pt dissolution.

However, for melting for a long period of time, e.g. at the time of stirring and fining, SiO₂ may be melted in glass at the time of melting, and the glass composition is changed, thus leading to devitrification or striae, and accordingly a Pt crucible is preferable to a quartz crucible. Further, a large-sized crucible is required for large-sized products or at the time of mass production, and a Pt crucible is less likely to be broken and thus have better handling efficiency than a quartz crucible. Further, a crucible should be complicatedly processed when a glass melt is withdrawn at the bottom of the crucible and formed, called a bottom withdrawal method, and a Pt crucible is preferable to a quartz crucible in view of the processability also.

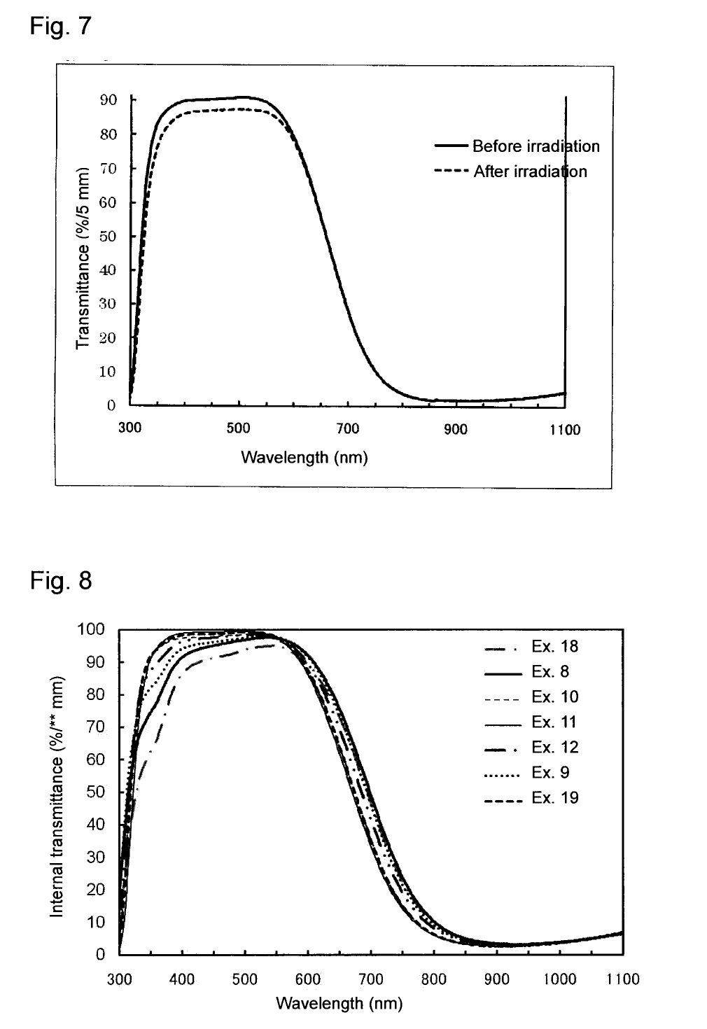

The present inventors have further studied the transmittance change and formation of the structural defects by irradiation with a high power laser having a wavelength in the ultraviolet region particularly a laser having a wavelength of 351 nm and as a result, found that the irradiation with the laser forms paramagnetic defects having a hole trapped in a P atom to which one or two non-bridging oxygens are bonded called POHC (phosphorus-oxygen-hole center) or paramagnetic defects having unpaired electrons having an electron trapped in a P atom called PO₂, PO₃ or PO₄, and as such structural defects have absorption in the ultraviolet region, the transmittance in the ultraviolet region is lowered. In FIG. 7, transmission spectra of a sample before and after irradiation at a wavelength of 351 nm with an irradiation power density of 4 J/cm² for 1,000 shots are shown.

Paramagnetic defects are obtained by electron spin resonance (ESR) measurement.

With respect to such paramagnetic detects, β-OH as a precursor thereof is considered, and accordingly it is preferred to reduce β-OH in glass, and its concentration is from 0.2 to 2.5. If it is higher than 2.5, the above-described paramagnetic defects are likely to form, and it is more preferably at most 2.0, further preferably at most 1.5, still further preferably at most 1.0. However, if it is too low, the oxidation-reduction state of glass tends to shift to the reduction side, Cu²+ which has absorption in the near infrared region tends to be converted to Cu⁺ which has absorption in the ultraviolet region, and accordingly the glass will hardly have an ultraviolet transmitting near infrared cutting performance. Accordingly, the concentration is preferably at least 0.5, more preferably at least 0.7.

To adjust the β-OH concentration, for example, a method of changing the materials used, a method of heating and drying the materials and then melting them, or a method of adjusting the dew point at the time of melting may be mentioned. Further, the β-OH concentration can be reduced also by prolonging the melting time.

β-OH was calculated by the following method. By means of an infrared spectrometer (AVATAR 370 manufactured by Nicolet), transmittances within a range of from 2,000 cm⁻¹ to 4,000 cm⁻¹ were measured with a data interval of about 2 cm⁻¹ and evaluated by means of an average value of 32 scans. Specifically, a glass sample having a size of 15 cm×15 mm×0.3 mm in thickness and having both surfaces in the thickness direction optically polished, was prepared and subjected to measurement. β-OH was determined in accordance with the formula (1) from the light transmittance T4 at 4,000 cm⁻¹ and the transmittance T3 at 3,000 cm⁻¹:

β-OH=−LOG(T3/T4)/0.3 (1)

Further, to suppress the paramagnetic defects formed by the laser irradiation as described above, it is preferred to dope glass with hydrogen molecules. The detailed mechanism of this is unclear, but it is considered that hydrogen molecules function as a repairing material against the paramagnetic defects formed by the laser irradiation and deactivate the defects. The hydrogen molecule concentration is at least 1×10¹⁵ molecules/cm³ and at most 1×10¹⁸ molecules/cm³. If the content is less than 1×10¹⁵ molecules/cm³, no sufficient effect will be obtained, and if it exceeds 1×10¹⁸ molecules/cm³, doping will take very long, and such is impractical. It is more preferably at least 5×10¹⁵ molecules/cm³ and at most 5×10¹⁷ molecules/cm³, more preferably at least 1×10¹⁶ molecules/cm³ and at most 1×10¹⁷ molecules/cm³.

A method of doping with hydrogen molecules is not particularly limited, and in view of efficiently forming Cu²⁺ and in view of the productivity, it is preferred to treat glass in a hydrogen-containing atmosphere after molding. There is also a method of blowing a hydrogen gas into a glass melt, but this is slightly inferior in view of the Cu²⁺ formation efficiency and the productivity.

The treatment temperature in a hydrogen-containing atmosphere is preferably within a range of from 100 to 500° C. If it is less than 100° C., it will take very long until the hydrogen gas is diffused into glass, and such is not efficient. It is more preferably at least 200° C., further preferably at least 250° C. On the other hand, if it exceeds 500° C., glass tends to be reduced, thus leading to a change in the valency of Cu ions i.e. Cu²+→Cu⁺, whereby absorption in the near infrared region will be reduced and absorption in the ultraviolet region will be increased, and accordingly the glass may not sufficiently function as an ultraviolet transmitting near infrared cut filter. It is preferably at most 400° C., more preferably at most 350° C.

The treatment in the hydrogen-containing atmosphere is preferably carried out in a hydrogen gas 100% or in a mixed gas atmosphere of a hydrogen gas and a nitrogen gas or an inert gas, under a pressure of the atmosphere of normal pressure (atmospheric pressure) or elevated pressure. Specifically, the hydrogen partial pressure is preferably at least 0.01 MPa and at most 1 MPa. If it is less than 0.01 MPa, the efficiency of doping with hydrogen molecules may be insufficient, and if it exceeds 1 MPa, e.g. an explosion-proof apparatus is required, and such is unfavorable in view of the production cost. Further, if the pressure is high, a concentration distribution of hydrogen gas is likely to occur between the glass surface and the inside, and the glass tends to be non-uniform. The pressure is preferably at least 0.05 MPa and at most 0.8 MPa, more preferably at least 0.1 MPa and at most 0.6 MPa.

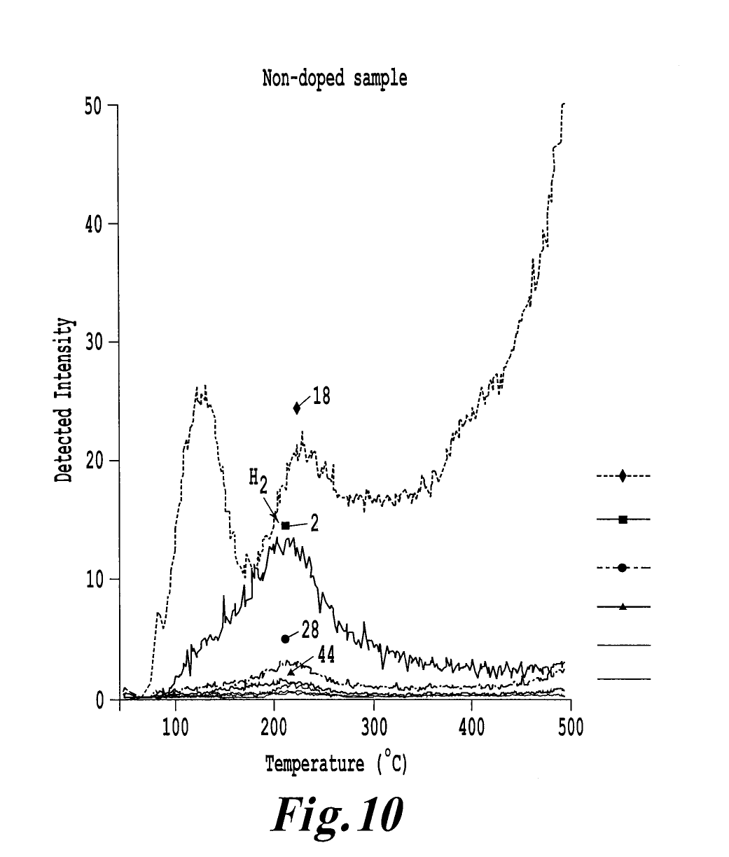

The hydrogen molecule concentration is measured by means of a thermal desorption spectrometer TDS (manufactured by ESCO, Ltd.) as follows. A glass sample not doped with hydrogen molecules was put in the thermal desorption spectrometer, the interior of the measurement chamber was vacuumed to 5×10⁻⁷ Pa or below and then the glass sample was heated, and the mass number of the generated gas was measured by a mass spectrometer placed in the thermal desorption spectrometer. The results are shown in FIG. 10.

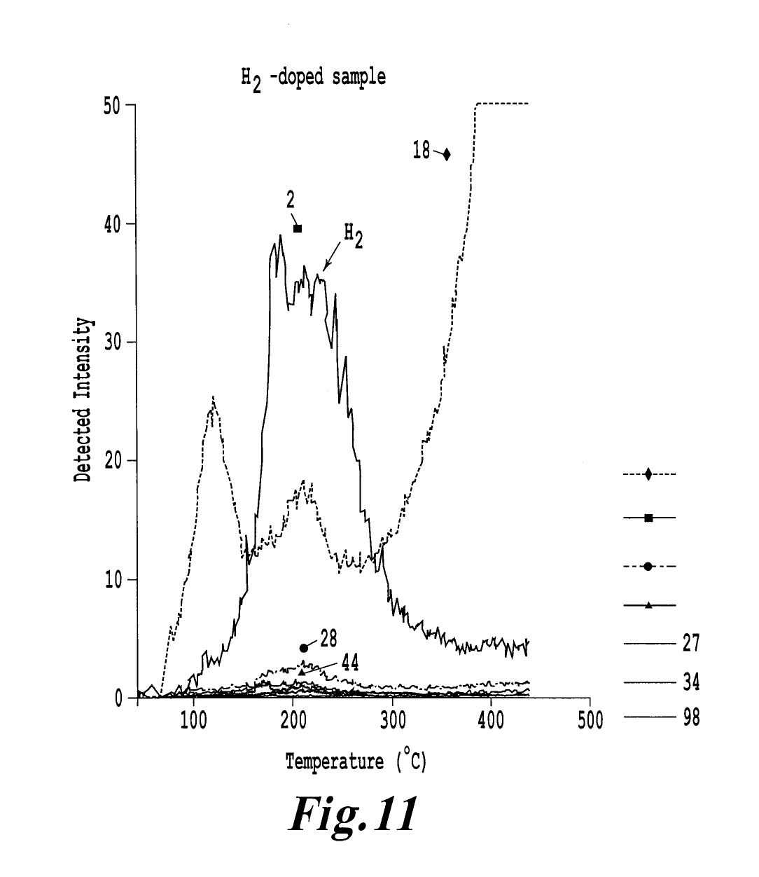

Then, a glass sample doped with hydrogen molecules was similarly put in the thermal desorption spectrometer, the interior of the measurement chamber was vacuumed to 5×10⁻⁷ Pa or below and then the glass sample was heated, and the mass number of the generated gas was measured. The results are shown in FIG. 11.

The integrated intensity of the difference between the measurement results of the glass sample doped with hydrogen molecules and the measurement results of the glass sample not doped with hydrogen molecules was regarded as the hydrogen molecule amount.

The number of hydrogen molecules which the measurement sample released can be calculated from the integrated intensity ratio of the above hydrogen molecule desorption peaks of the measurement sample relative to a standard sample having a known hydrogen molecule concentration. For example, as the standard sample, silicon having hydrogen ion-implanted may be used.

As the spectral characteristics of the ultraviolet transmitting near infrared cut filter glass of the present invention, the internal transmittance at a wavelength of 351 nm with a thickness of 5 mm is preferably at least 75%, more preferably at least 77%, further preferably at least 79%. Further, the internal transmittance at a wavelength of 375 nm is preferably at least 50%, more preferably at least 75%, further preferably at least 85%.

Further, the internal transmittance at a wavelength of 666 nm is preferably at least 40%, more preferably at least 43%, further preferably at least 45%. Further, the internal transmittance at a wavelength of 1,053 nm is preferably at most 20%, more preferably at most 15%, further preferably at most 12%.

Otherwise, the internal transmittance at a wavelength of 532 nm is preferably at most 20%, more preferably at most 15%, further preferably at most 10%. Further, the internal transmittance at a wavelength of 1,053 nm is preferably at most 20%, more preferably at most 15%, further preferably at most 12%.

Of the ultraviolet transmitting near infrared cut filter glass of the present invention, the thickness is preferably from 0.3 to 15 mm in view of the balance between the strength and the mass. If the thickness is less than 0.3 mm, the strength tends to be insufficient, and the thickness is more preferably at least 0.5 mm in view of the strength, particularly preferably at least 0.7 mm. On the other hand, if the thickness exceeds 15 mm, there may be a problem in view of weight saving. The thickness is preferably at most 13 mm in view of weight saving, particularly preferably at most 11 mm.

Of the ultraviolet transmitting near infrared cut filter glass of the present invention, the density of the internal defects is preferably at least 5×10⁻⁶ defects/cm³ and at most 5×10 ⁻⁴ defects/cm³. If the density of the internal defects is less than 5×10⁻⁶ defects/cm³, the range of the conditions under which production is possible is very limited, such that a special bubbling means or reduction in the melting temperature is required to reduce the internal defects, and such may lead to an extreme increase in the production cost. On the other hand, if the density exceeds 5×10⁻⁴ defects/cm³, such may be practically problematic in the case of a large-sized glass having a size of 400 mm×400 mm×10 mm in thickness for example, and such is not suitable for a large-sized filter glass.

In this specification, the internal defects are evaluated by visually inspecting the glass in a state where the glass surface is mirror-polished, by means of a high luminance light source with a luminance of at least 2,000 lux. By this evaluation, bubbles and inclusions with a size of at least 5 μm can be detected.

Here, the internal defects mean bubbles, Pt inclusions and striae. If there are bubbles or inclusions, when glass is irradiated with a laser for example, the glass will be damaged originating from the bubbles or the inclusions. In a worse case, the glass may be broken.

Further, if there are striae, glass will be optically non-uniform, and the transmitted light is distorted. To reduce the bubbles or the inclusions, usually a means of adding a component having a fining effect or a means of sufficiently stirring may be applied. With respect to inclusions particularly Pt inclusions, elution of Pt inclusions can be suppressed by lowering the glass liquid phase temperature or by increasing the solubility of Pt in glass. The phosphate glass of the present invention usually has a high Pt solubility as compared with fluorophosphates glass or silicate glass and is suitable to suppress Pt inclusions. Further, to increase the solubility of Pt in glass, blowing of POCl₃ or O₂ into a glass melt may also be applicable. On the other hand, as described above, in the glass of the present invention, Pt dissolved in the glass has absorption in the ultraviolet region, and accordingly it is not necessarily preferred to increase the solubility.

The ultraviolet transmitting near infrared cut filter glass of the present invention can be prepared as follows. First, materials are weighed and mixed so that the obtainable glass has a composition within the above range. This material mixture is put in a platinum crucible, and heated and melted at a temperature of from 900 to 1,400° C. in an electric furnace. After sufficient stirring and fining, the melt is cast into a mold, annealed and then cut and polished to form the glass into a plate having a predetermined thickness.

The ultraviolet transmitting near infrared cut filter glass of the present invention is also characterized in that the glass is stable, by having the above glass constitution. The glass being stable is defined by both of the stability in a temperature range in the vicinity of the liquid phase temperature and the stability in a temperature range in the vicinity of the glass transition point Tg. Specifically, the stability in a temperature range in the vicinity of the liquid phase temperature means a low liquid phase temperature and a slow progress of devitrification in the vicinity of the liquid phase temperature. The stability in a temperature range in the vicinity of the glass transition point Tg means a high crystallization temperature Tc, a high crystallization starting temperature Tx and a slow progress of devitrification in the vicinity of Tc and Tx. When they are achieved, devitrification is less likely to occur in a step of melting and forming glass, whereby glass can easily be produced with a high yield.

The ultraviolet transmitting near infrared cut filter glass of the present invention has an excellent near infrared shielding property as mentioned above, and is excellent in the devitrification resistance since it is stable glass. Accordingly, it is useful as a near infrared cut filter glass for high power laser optics.

Further, it is possible to improve the near infrared light shielding property while maintaining a high ultraviolet transmittance of the near infrared cut filter glass without increasing the CuO content in glass or providing a dielectric multilayer film (near infrared shielding film). It is of course possible to provide a dielectric multilayer film (near infrared shielding film) to the ultraviolet transmitting near infrared cut filter glass of the present invention so as to obtain desired spectral characteristic. However, as the glass has a high near infrared shielding property, the number of layers of the dielectric multilayer film to be provided can be reduced, and even when a dielectric multilayer film is provided on the glass, the cost for production of the ultraviolet transmitting near infrared cut filter glass can be reduced as compared with conventional product.

### EXAMPLES

Examples of the present invention (Examples 1 to 4, 8 to 13, 16 and 17) and Comparative Examples (Examples 5 to 7, 14 and 15) are shown in Tables 1 to 4. In Tables, the internal transmittances at wavelengths λ=351 nm, 375 nm, 532 nm, 666 nm and 1,053 nm with a sample thickness of 5 mm are respectively abbreviated as T₃₅₁, T₃₇₅, T₅₃₂, T₆₆₆ and T₁₀₅₃. Chemical components in Tables 1 and 2 are represented by mass %, and chemical components in Tables 3 and 4 are represented by mol %. The melting temperature and the thickness when the internal transmittance at a wavelength of 1,053 nm becomes 5%, and the internal transmittance at a wavelength of 351 nm with this thickness, and the Pt ion concentration in Examples of the present invention (Examples 8 to 12, 18 and 19) are shown in Table 5. In Examples 18 and 19, the chemical composition is the same as in Example 10, and the melting temperature is different from that in Example 10.

The melting time, β-OH and the dew point in Examples of the present invention (Examples 10 and 20 to 24) are shown in Table 6. In Examples 20 to 24, the glass was prepared in the same manner as in Example 10 except for the melting time and the dew point.

To produce the glasses, materials were weighed and mixed to achieve the composition (mass %) as shown in Tables 1 and 2, put in a platinum crucible having an internal capacity of about 300 cc, melted, fined and stirred at from 900 to 1,400° C. for from 1 to 12 hours, and the melt was cast into a rectangular mold having a size of 100 mm×50 mm×15 mm in height preheated at from about 400 to about 600° C., and then annealed at about 1° C./min to prepare samples. The melting property and the like of the glasses were visually observed when the above samples were prepared, and the obtained glass samples were confirmed to have no bubbles, inclusions or striae.

In Example 25 which is an Example of the present invention, a sample was prepared in the same manner as in Example 10, followed by treatment at 300° C. under a hydrogen partial pressure of 0.01 MPa for 80 hours. As a result, the concentration of hydrogen molecules doped was 2.2×10¹⁷ molecules/cm³.

Each of the glasses having a thickness of 5 mm in Examples 21, 23 and 25 was irradiated with a pulse laser having a wavelength of 355 nm and an irradiation power density of 10 J/cm² for 100 shots, the transmittance was measured at a wavelength within a range of from 300 nm to 1,100 nm before and after the irradiation to obtain the transmittance change ΔT₃₅₁ at a wavelength of 351 nm i.e. a value obtained by subtracting the transmittance after irradiation from the transmittance before irradiation, which is shown in Table 7.

As the materials of each glass, H₃PO₄ or a metaphosphate material was used in the case of P₂O₅, Al(PO₃)₃ or Al₂O₃ in the case of Al₂O₃, BPO₃ in the case of B₂O₃, NaPO₃ in the case of Na₂O, KPO₃ in the case of K₂O, BaPO₃ in the case of BaO, CuO in the case of CuO, Co₃O₄ in the case of Co₃O₄, and Sb₂O₃ in the case of Sb₂O₃.

Each of the above-prepared glasses was evaluated by the following method with respect to the transmittance.

The internal transmittance was evaluated by means of an ultraviolet visible near infrared spectrophotometer (manufactured by PerkinElmer Japan Co., Ltd., tradename: LAMBDA 950). Specifically, two glass samples having a size of 15 mm×15 mm and having an optional thickness of from 1 to 10 mm, and having both surfaces in the thickness direction optically polished, were prepared and subjected to measurement. From the light transmittances T1 and T2 at the respective wavelengths of two samples having thicknesses t1 and t2, the internal light transmittance T_{λ} at a wavelength λ with a thickness tx(mm) was determined in accordance with the formula (2):

T_{λ}(%/tx(mm))=exp(ln(T1/T2)/(t1/t2)×tx)×100 (2)

TABLE 1

| mass % | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| P₂O₅ | 80.5 | 77.4 | 70.3 | 61.0 | 76.4 | 69.0 | 75.3 | 76.6 | 74.1 |
| Al₂O₃ | 9.5 | 9.1 | 8.9 | 8.4 | 11.4 | 8.5 | 6.9 | 9.0 | 9.1 |
| B₂O₃ | 1.7 | 1.6 | 1.6 | 1.5 | 0.0 | 1.0 | 0.8 | 1.6 | 1.6 |
| Na₂O | 6.8 | 0.0 | 7.3 | 6.9 | 6.4 | 7.0 | 3.4 | 0.0 | 0.0 |
| K₂O | 0.0 | 10.4 | 0.0 | 0.0 | 0.0 | 0.0 | 0.0 | 11.3 | 13.6 |
| BaO | 1.0 | 1.0 | 11.7 | 22.0 | 1.0 | 8.9 | 13.5 | 1.0 | 1.0 |
| CuO | 0.5 | 0.5 | 0.2 | 0.2 | 4.9 | 4.6 | 0.0 | 0.2 | 0.2 |
| Co₃O₄ | 0.0 | 0.0 | 0.0 | 0.0 | 0.0 | 0.0 | 0.0 | 0.0 | 0.0 |
| Sb₂O₃ | 0.0 | 0.0 | 0.0 | 0.0 | 0.0 | 1.1 | 0.0 | 0.3 | 0.3 |
| N + K + L | 6.8 | 10.4 | 7.3 | 6.9 | 6.4 | 7.0 | 3.4 | 11.3 | 13.6 |
| M + C + S + B | 1.0 | 1.0 | 11.7 | 22.0 | 1.0 | 8.9 | 13.5 | 1.0 | 1.0 |
| P/(A + B) | 7.2 | 7.2 | 6.7 | 6.2 | 6.7 | 7.2 | 9.8 | 7.2 | 6.9 |
| (N + K)/(L + | 6.8 | 10.4 | 0.6 | 0.3 | 6.4 | 0.8 | 0.3 | 11.1 | 13.2 |
| M + C + S + B) | | | | | | | | | |
| T₃₅₁/% | 80.8 | 86.7 | 92.5 | 85.6 | 10.4 | 25.2 | 92.8 | 84.1 | 89.0 |
| T₃₇₅/% | 88.6 | 92.2 | 96.2 | 94.4 | 23.3 | 56.8 | 93.3 | 90.2 | 93.2 |
| T₅₃₂/% | 98.6 | 98.7 | 97.2 | 96.4 | 75.2 | 81.6 | 94.1 | 98.5 | 98.9 |
| T₆₆₆/% | 45.4 | 59.4 | 48.7 | 45.5 | 0.0 | 0.0 | 94.5 | 79.6 | 78.1 |
| T₁₀₅₃/% | 1.1 | 1.4 | 6.2 | 10.2 | 0.0 | 0.0 | 96.8 | 16.8 | 17.2 |

TABLE 2

| | Ex. | Ex. | Ex. | Ex. | Ex. | Ex. | Ex. | Ex. |
|---|---|---|---|---|---|---|---|---|
| mass % | 10 | 11 | 12 | 13 | 14 | 15 | 16 | 17 |
| P₂O₅ | 67.3 | 65.4 | 72.8 | 69.5 | 76.7 | 67.6 | 67.1 | 66.0 |
| Al₂O₃ | 8.6 | 7.8 | 9.3 | 8.9 | 9.1 | 8.6 | 8.2 | 8.1 |
| B₂O₃ | 1.5 | 2.0 | 2.7 | 2.1 | 1.6 | 1.5 | 1.5 | 2.1 |
| Na₂O | 0.0 | 0.0 | 0.0 | 0.0 | 0.0 | 0.0 | 0.0 | 0.0 |
| K₂O | 10.7 | 11.4 | 13.4 | 11.8 | 11.3 | 10.7 | 10.6 | 11.5 |
| BaO | 11.2 | 12.3 | 1.0 | 7.0 | 1.0 | 11.2 | 11.1 | 11.3 |
| CuO | 0.3 | 0.5 | 0.4 | 0.4 | 0.0 | 0.0 | 0.5 | 0.4 |
| Co₃O₄ | 0.0 | 0.0 | 0.0 | 0.0 | 0.0 | 0.0 | 0.6 | 0.4 |
| Sb₂O₃ | 0.4 | 0.6 | 0.3 | 0.3 | 0.3 | 0.3 | 0.4 | 0.3 |
| N + K + L | 10.7 | 11.4 | 13.4 | 11.8 | 11.3 | 10.7 | 10.6 | 11.5 |
| M + C + S + B | 11.2 | 12.3 | 1.0 | 7.0 | 1.0 | 11.2 | 11.1 | 11.3 |
| P/(A + B) | 6.7 | 6.6 | 6.1 | 6.3 | 7.2 | 6.7 | 6.9 | 6.5 |
| (N + K)/(L + | 1.0 | 0.9 | 12.9 | 1.7 | 11.1 | 1.0 | 1.0 | 1.0 |
| M + C + | | | | | | | | |
| S + B) | | | | | | | | |
| T₃₅₁/% | 90.9 | 86.0 | 85.0 | 89.9 | 86.0 | 96.5 | 84.1 | 77.3 |
| T₃₇₅/% | 95.2 | 95.3 | 91.2 | 94.5 | 89.6 | 97.7 | 93.6 | 92.9 |
| T₅₃₂/% | 97.9 | 98.0 | 98.0 | 98.0 | 97.0 | 99.5 | 7.7 | 8.5 |
| T₆₆₆/% | 50.1 | 35.2 | 54.3 | 51.1 | 98.2 | 99.2 | 15.4 | 14.2 |
| T₁₀₅₃/% | 3.1 | 0.8 | 2.5 | 2.8 | 99.7 | 99.4 | 0.7 | 2.8 |

TABLE 3

| mol % | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| P₂O₅ | 69.4 | 69.4 | 61.7 | 54.3 | 64.8 | 59.6 | 70.4 | 69.1 | 66.1 |
| Al₂O₃ | 11.4 | 11.4 | 10.9 | 10.4 | 13.4 | 10.2 | 8.9 | 11.4 | 11.4 |
| B₂O₃ | 3.0 | 3.0 | 2.8 | 2.7 | 0.0 | 1.8 | 1.6 | 3.0 | 3.0 |
| Na₂O | 14.4 | 0.0 | 14.7 | 14.0 | 13.4 | 13.8 | 7.3 | 0.0 | 0.0 |
| K₂O | 0.0 | 14.4 | 0.0 | 0.0 | 0.0 | 0.0 | 0.0 | 15.3 | 18.3 |
| BaO | 1.0 | 1.0 | 9.5 | 18.1 | 1.0 | 7.1 | 11.7 | 0.8 | 0.8 |
| CuO | 0.8 | 0.8 | 0.4 | 0.4 | 7.4 | 7.1 | 0.0 | 0.3 | 0.3 |
| Co₃O₄ | 0.0 | 0.0 | 0.0 | 0.0 | 0.0 | 0.0 | 0.0 | 0.0 | 0.0 |
| Sb₂O₃ | 0.0 | 0.0 | 0.0 | 0.0 | 0.0 | 0.4 | 0.0 | 0.1 | 0.1 |
| N + K + L | 14.4 | 14.4 | 14.7 | 14.0 | 13.4 | 13.8 | 7.3 | 15.3 | 18.3 |
| M + C + S + B | 1.0 | 1.0 | 9.5 | 18.1 | 1.0 | 7.1 | 11.7 | 0.8 | 0.8 |
| P/(A + B) | 4.8 | 4.8 | 4.5 | 4.1 | 4.8 | 5.0 | 6.7 | 4.8 | 4.6 |
| (N + K)/(L + | 14.4 | 14.4 | 1.6 | 0.8 | 13.4 | 1.9 | 0.6 | 18.0 | 21.5 |
| M + C + S + B) | | | | | | | | | |

TABLE 4

| | Ex. | Ex. | Ex. | Ex. | Ex. | Ex. | Ex. | Ex. |
|---|---|---|---|---|---|---|---|---|
| mol % | 10 | 11 | 12 | 13 | 14 | 15 | 16 | 17 |
| P₂O₅ | 61.4 | 59.4 | 64.3 | 62.5 | 69.3 | 61.8 | 61.6 | 59.9 |
| Al₂O₃ | 10.9 | 9.9 | 11.4 | 11.1 | 11.4 | 10.9 | 10.4 | 10.3 |
| B₂O₃ | 2.8 | 3.8 | 4.9 | 3.9 | 3.0 | 2.9 | 2.8 | 3.8 |
| Na₂O | 0.0 | 0.0 | 0.0 | 0.0 | 0.0 | 0.0 | 0.0 | 0.0 |
| K₂O | 14.7 | 15.6 | 17.8 | 16.0 | 15.3 | 14.7 | 14.7 | 15.7 |
| BaO | 9.5 | 10.4 | 0.8 | 5.8 | 0.9 | 9.5 | 9.5 | 9.5 |
| CuO | 0.6 | 0.8 | 0.6 | 0.6 | 0.0 | 0.0 | 0.8 | 0.6 |
| Co₃O₄ | 0.0 | 0.0 | 0.0 | 0.0 | 0.0 | 0.0 | 0.2 | 0.1 |
| Sb₂O₃ | 0.2 | 0.3 | 0.1 | 0.1 | 0.1 | 0.1 | 0.3 | 0.2 |
| N + K + L | 14.7 | 15.6 | 17.8 | 16.0 | 15.3 | 14.7 | 14.7 | 15.7 |
| M + C + S + B | 9.5 | 10.4 | 0.8 | 5.8 | 0.9 | 9.5 | 9.5 | 9.5 |
| P/(A + B) | 4.5 | 4.3 | 3.9 | 4.2 | 4.8 | 4.5 | 4.6 | 4.3 |
| (N + K)/(L + | 1.6 | 1.5 | 22.5 | 2.8 | 18.0 | 1.6 | 1.6 | 1.7 |
| M + C + | | | | | | | | |
| S + B) | | | | | | | | |

TABLE 5

| | | Internal | | Pt ion |
|---|---|---|---|---|
| | Melting | transmittance | Thickness | concentration |
| | temperature | at 351 nm | (mm) | (μg/g) |
| Ex. 18 | 1350 | 62.7 | 7.8 | 52 |
| Ex. 8 | 1300 | 74.7 | 8.4 | |
| Ex. 9 | 1250 | 82.1 | 8.5 | |
| Ex. 12 | 1200 | 87.7 | 4.0 | |
| Ex. 10 | 1150 | 92.1 | 4.3 | 5 |
| Ex. 19 | 1100 | 92.0 | 4.0 | |
| Ex. 11 | 1050 | 91.1 | 3.1 | |

TABLE 6

| | | | Transmit- | Transmit- | | |
|---|---|---|---|---|---|---|
| | Melting | Dew | tance | tance | Thick- | |
| | time | point | at 3000 | at 4000 | ness | β-OH |
| | (hr) | (° C.) | cm⁻¹ (%) | cm⁻¹ (%) | (mm) | (mm⁻¹) |
| Ex. 10 | 3.0 | 33.5 | 22.5 | 88.7 | 0.3 | 2.0 |
| Ex. 20 | 3.0 | 27.4 | 28.0 | 89.9 | 0.3 | 1.7 |
| Ex. 21 | 3.0 | 1.8 | 33.9 | 90.5 | 0.3 | 1.4 |
| Ex. 22 | 4.0 | 4.3 | 39.7 | 91.3 | 0.3 | 1.2 |
| Ex. 23 | 6.0 | 8.4 | 53.3 | 92.4 | 0.3 | 0.8 |
| Ex. 24 | 12.0 | 1.8 | 48.6 | 92.1 | 0.3 | 0.9 |

TABLE 7

| | ΔT₃₅₁ (%) |
|---|---|
| Ex. 21 | 5.2 |
| Ex. 23 | 3.8 |
| Ex. 25 | 3.4 |

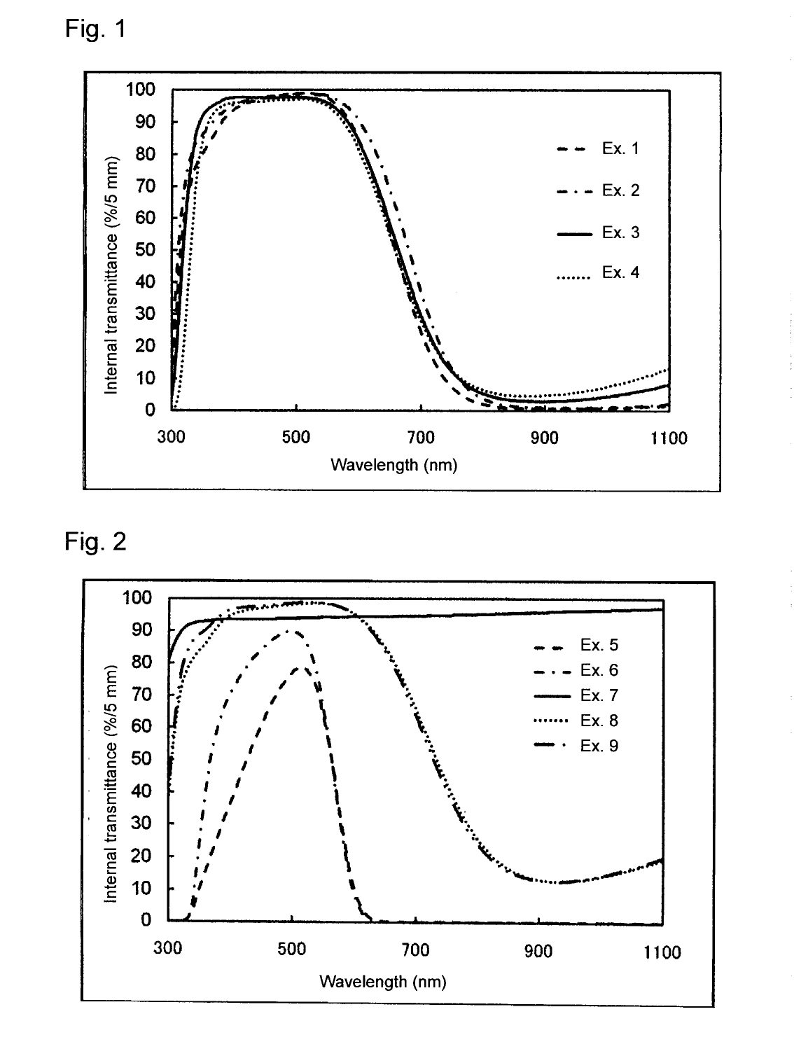

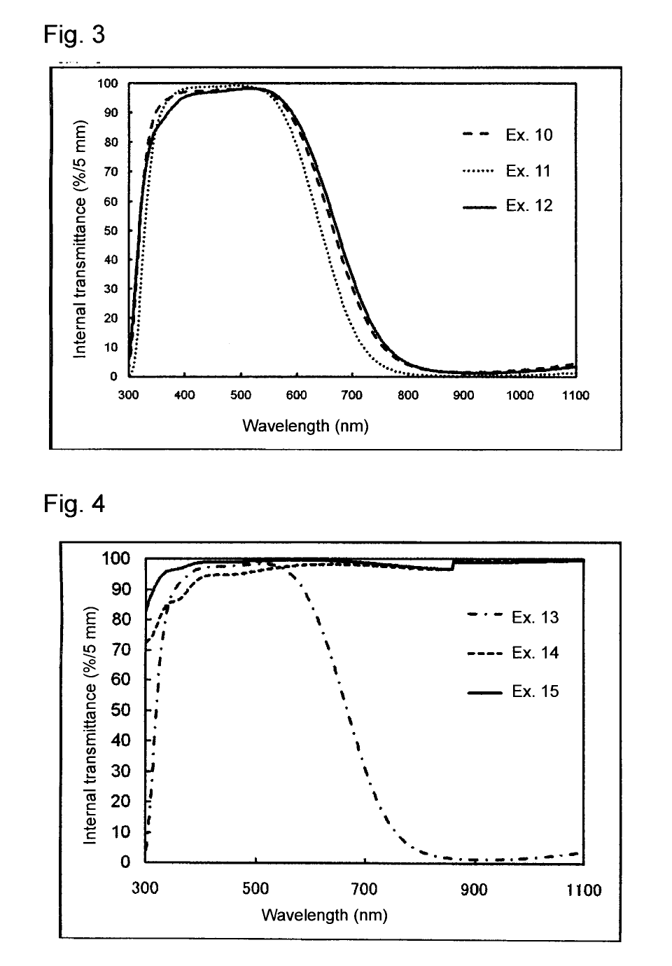

Internal transmittance characteristic curves of the glasses in Examples 1 to 15 are shown in FIGS. 1 to 4. It is found that each of the glasses in Examples of the present invention (Examples 1 to 4 and 10 to 13) has a high internal transmittance in the ultraviolet region in the vicinity of 350 nm while having a near infrared shielding function in the vicinity of from 1,000 to 1,100 nm. On the other hand, it is found that each of the glasses in Comparative Examples (Examples 5 to 9, 14 and 15) has a poor near infrared shielding property if it has a high transmittance in the vicinity of 350 nm, or has a poor transmittance in the vicinity of 350 nm if it has a high near infrared shielding property.

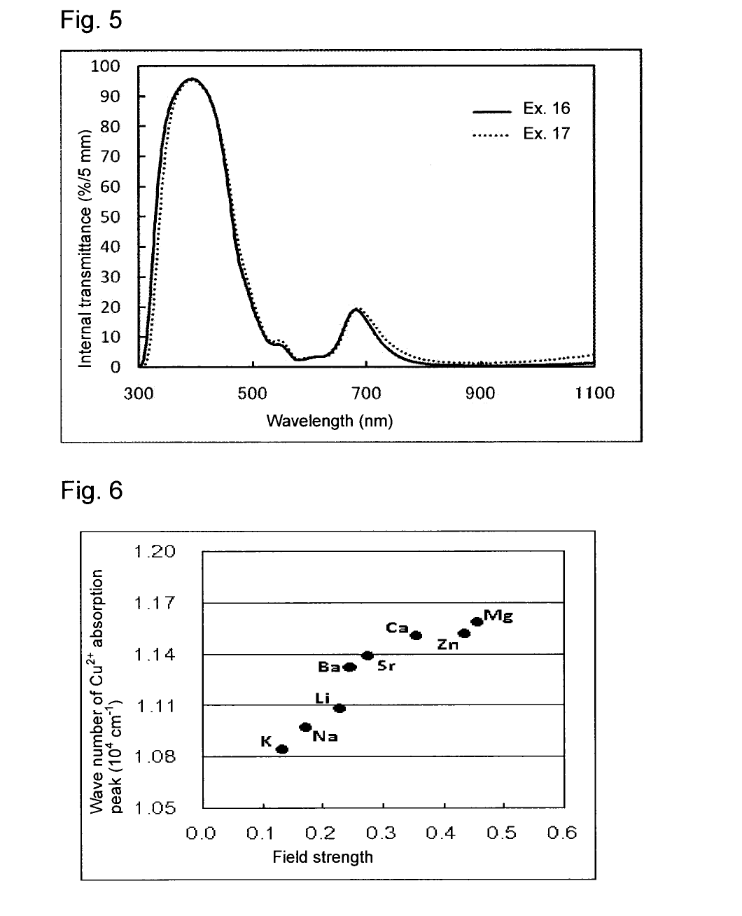

Further, the internal transmittance characteristic curves of the glasses in Examples 16 and 17 are shown in FIG. 5. It is found that by addition of Co₃O₄, the obtainable glass has a high internal transmittance in the ultraviolet region in the vicinity of 350 nm while having a shielding function in the near infrared region in the vicinity of from 1,000 to 1,100 nm and in the vicinity of 532 nm.

Accordingly, the ultraviolet transmitting near infrared cut filter glass of the present invention is useful as glass which cuts off the second harmonic at 532 nm which is a leaked light and the fundamental wave at 1,053 nm in the near infrared region while maintaining a transmittance of the third harmonic at 351 nm which is the wavelength of the high power laser.

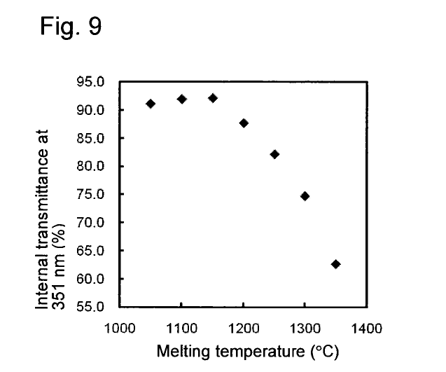

In FIG. 8, internal transmittance spectra of the glasses in Examples 8 to 12, 18 and 19 when the thickness is adjusted so that the internal transmittance at a wavelength of 1,053 nm becomes 5% are shown. Further, in FIG. 9, the relation between the internal transmittance at a wavelength of 351 nm and the melting temperature of each of the glasses in Examples 8 to 12, 18 and 19 when the thickness is adjusted so that the internal transmittance at 1,053 nm becomes 5% is shown. It is found that the transmittance at 351 nm decreases at a melting temperature of 1,200° C. or higher.

It is found from Table 7 that a decrease in the transmittance at the time of irradiation with laser is smaller in Example 23 in which the β-OH concentration is low and in Example 25 in which the glass is doped with hydrogen molecules.

### INDUSTRIAL APPLICABILITY

According to the present invention, when phosphate glass has a glass composition within a specific range, by making the field strength of the modifier oxide to be small, Cu²+ in the glass can has a higher function to absorb light in the near infrared region. Accordingly, it is possible to provide ultraviolet transmitting near infrared cut filter glass which can suppress a transmittance of light in the near infrared region to be low while maintaining a high transmittance in the ultraviolet to visible regions with a smaller amount of doping with Cu.

This application is a continuation of PCT Application No. PCT/JP2011/059984, filed on Apr. 22, 2011, which is based upon and claims the benefit of priorities from Japanese Patent Application No. 2010-100056 filed on Apr. 23, 2010 and Japanese Patent Application No. 2010-158708 filed on Jul. 13, 2010. The contents of those applications are incorporated herein by reference in its entirety.

What is claimed is:

1. Ultraviolet transmitting near infrared cut filter glass comprising, as represented by mass %:
P₂O₅: 50 to 85%,
Al₂O₃: 1 to 20%,
B₂O₃: 1 to 5%,
Li₂O: 0 to 2%,
Na₂O: 0 to 15%,
K₂O: 0 to 20%,
Li₂O+Na₂O+K₂O: 7 to 20%,
MgO: 0 to 2%,
CaO: 0 to 1%,
SrO: 0 to 4%,
BaO: 1 to 22%,
MgO+CaO+SrO+BaO: 0.5 to 22%,
CuO: 0.1 to 2%,
Co₃O₄: 0 to 1% and
Sb₂O₃ 0 to 5%.

2. The ultraviolet transmitting near infrared cut filter glass according to claim 1, wherein P₂O₅/(Al₂O₃+B₂O₃)=3 to 15 and (Na₂O+K₂O)/(Li₂O+MgO+CaO+SrO+BaO)=0.1 to 15.

3. The ultraviolet transmitting near infrared cut filter glass according to claim 1, wherein the hydrogen molecule concentration in the glass doped with hydrogen molecules is at least 1×10¹⁵ molecules/cm³ and at most 1×10¹⁸ molecules/cm³.

4. The ultraviolet transmitting near infrared cut filter glass according to claim 1, wherein the 6—OH concentration is at least 0.2 and at most 2.5.

5. The ultraviolet transmitting near infrared cut filter glass according to claim 1, wherein the temperature when the glass is melted is at most 1,200° C.

6. The ultraviolet transmitting near infrared cut filter glass according to claim 1, which has an internal transmittance at a wavelength of 351 nm of at least 75%, and an internal transmittance at a wavelength of 1,053 nm of at most 20%.

7. The ultraviolet transmitting near infrared cut filter glass according to claim 6, which has an internal transmittance at a wavelength of 375 nm of at least 50%.

8. The ultraviolet transmitting near infrared cut filter glass according to claim 6, which has an internal transmittance at a wavelength of 532 nm of at most 20%.

9. The ultraviolet transmitting near infrared cut filter glass according to claims 6, which has an internal transmittance at a wavelength of 666 nm of at least 40%.

10. The ultraviolet transmitting near infrared cut filter glass according to claim 1, which has a thickness of from 0.3 to 15 mm.

11. The ultraviolet transmitting near infrared cut filter glass according to claim 1, which has a Pt content of at most 15 μg/g.

12. A method for producing the ultraviolet transmitting near infrared cut filter glass as defined in claim 3, which comprises weighing, mixing and melting glass materials, and casting the molten glass into a mold, followed by a treatment in a hydrogen gas atmosphere.

13. The method for producing the ultraviolet transmitting near infrared cut filter glass according to claim 12, wherein the hydrogen doping is carried out at a temperature of at least 100° C. and at most 500° C. under a hydrogen partial pressure of at least 0.01 MPa and at most 1 MPa.
